(19) United States
(12) Patent Application Publication
(10) Pub. No.: US 2002/0013851 A1
(43) Pub. Date: Jan. 31, 2002

(54) Simultaneous recording of multiple information streams

(76) Inventor: Evan Stephen Crandall, Basking Ridge, NJ (US)

Correspondence Address: S. H. Dworetsky, AT&T Corp., P.O. Box 4110, Middletown, NJ, 07748, US

(21) Appl. No.: 09/775,586

(22) Filed: Feb. 5, 2001

Related U.S. Application Data
(63) Continuation-in-part of application No. 09/597,428, filed on Jun. 20, 2000.

(51) Int. Cl. G06F 15/16; G06F 15/173

(52) U.S. Cl. 709/231; 709/223

(57) ABSTRACT

A performance reproduction devices simultaneously records performance information from a plurality of information streams. The performance information may include entire programs, such as movies, radio programs or the like, or may include commands for generating a performance using a pseudo-live performance generator (PLPG) and previously-stored information. Performance description information may be extracted from the received performance information and categorized and/or indexed to allow a viewer to easily sort through recorded performances and determine which performance to watch. Performances may be generated using information simultaneously received from different information streams. For example, a viewer may watch a movie that is reproduced based on information received from one channel, with the commercials that are normally interspersed throughout the movie being replaced with commercials reproduced based on information received from another channel.

This application is a Continuation-In-Part of prior pending application Ser. No. 09/597,428, filed on Jun. 20, 2000.

### RELATED APPLICATIONS

This application is related to co-pending application Ser. No. 09/597,127, filed on Jun. 20, 2000;______, filed on______; and______, filed on______.

### BACKGROUND OF THE INVENTION

1. Field of Invention

This invention relates to recording and reproducing performances.

2. Description of Related Art

Current performance recording devices, such as VCRs and the like, record information from an information stream, such as a television channel. New technology could offer improved functions over that performed by recording devices such as the VCR.

### SUMMARY OF THE INVENTION

However, if a viewer wishes to record separate programs that are being simultaneously broadcast on separate information streams, the viewer cannot do so using a conventional VCR.

An object of this invention is to provide performance recording devices that can simultaneously record performance information from a plurality of information streams.

The performance information may include entire programs, such as movies, radio programs or the like, or may include commands for generating a performance using a pseudo-live performance generator (PLPG) and previously-stored information as described in the parent application, application Ser. No. 09/597,428.

Performance description information may be extracted from the received performance information and categorized and/or indexed to allow a viewer to easily sort through recorded performances and determine which performance to watch.

Performances may be generated using information simultaneously received from different information streams. For example, a viewer may watch a movie that is reproduced based on information received from one channel, with the commercials that are normally interspersed throughout the movie being replaced with commercials reproduced based on information received from another channel.

Performances may be synthesized using stored video and/or audio information. For example, a video of a “virtual weatherman” giving a weather report based on text or other data received from one or more information streams may be generated.

These and other features and advantages of this invention are described in or are apparent from the following detailed description of exemplary embodiments.

### BRIEF DESCRIPTION OF THE DRAWINGS

This invention will be described in detail with reference to the following figures, wherein like numerals represent like elements, and wherein:

FIG. 1 is a diagram of a multiple-channel performance recording system;

FIG. 2 is an exemplary block diagram of a performance transmitter of FIG. 1;

FIG. 3 is a flowchart of an exemplary method for transmitting a performance;

FIG. 4 is an exemplary block diagram of a performance reproduction device of FIG. 1;

FIG. 5 is an exemplary diagram showing content of a storage device of FIG. 1;

FIGS. 6-8 show exemplary diagrams of command sequences;

FIG. 9 is a diagram of a multiple-channel performance recording device;

FIG. 10 is a flowchart of an exemplary method for recording a performance; and

FIG. 11 is a flowchart of an exemplary method for generating and displaying a performance index.

### DETAILED DESCRIPTION OF PREFERRED EMBODIMENTS

In typical radio or television transmission, a transmitting station transmits a mix of real-time performance, such as local news, weather forecasts and real-time comments by the announcer or disk jockey, for example, and stored information, such as movies, songs, advertisements and/or the like. The transmission of the performance is synchronized with the output of the performance by an output device such as a radio or television set. Depending on a particular programming, the real-time performance may constitute a relatively small portion of the total transmission of the broadcasting station.

If information, such as entire libraries of songs or movies, for example, are stored locally near end-users, this information can be accessed and reproduced in response to commands received from a transmitting station via a network. Instead of transmitting entire songs or movies, for example, the radio or television station can transmit a command for an end-user's performance reproduction device to reproduce the song or movie. The end-user's performance reproduction device, such as an enhanced radio or a television set, may access and reproduce the locally stored song or movie based on received commands. Since the radio or television station need not transmit the entire performance, network traffic can be significantly reduced. Additionally, since information is stored at or near the performance reproduction device and subsequently reproduced, commands and/or other information necessary to generate a performance may be transmitted asynchronously with generation of a performance. The commands and/or other information may be transmitted at speeds faster or slower than the performance. Thus, any available network resources may be used independent of the speed of transmission. Therefore, network resources may be utilized more efficiently.

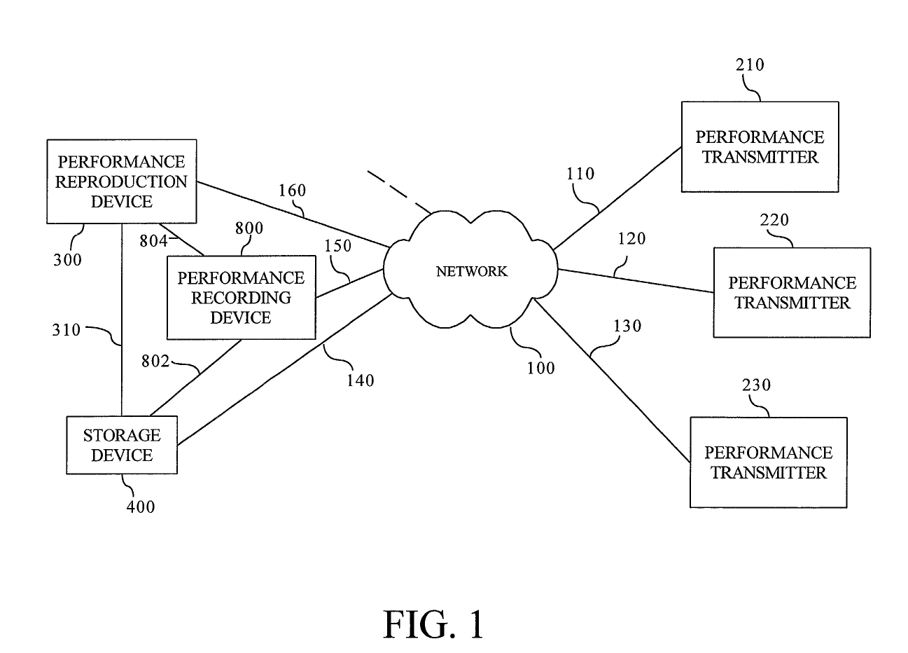

FIG. 1 is a diagram of a network 100 that couples a plurality of performance transmitters 210, 220 and 230 to a performance reproduction device 300, a storage device 400 and a performance recording device 800. The network 100 may be any type of network or combinations of networks such as a cable network, telephone network, data network, broadcasting network, or the like over any type of medium, such as wired, wireless or optical.

The performance transmitters 210, 220 and 230 may be, for example, radio or television broadcasting stations or any other type of performance transmitter adapted to transmit performance information to the performance reproduction device 300, the storage device 400 and/or the performance recording device 800. The performance transmitters 210, 220 and 230 are coupled to the network 100 by respective links 110, 120 and 130, which may also be either wired, wireless or optical, for example.

The performance reproduction device 300 may be coupled to the network 100 via a link 160, which may also be either wired, wireless or optical, for example. The performance reproduction device 300 may be, for example, a radio or television set of an end-user.

A storage device 400 is accessible by the performance reproduction device 300, and may be a mass storage device capable of storing a large quantity of information on the order of terabits or more, for example. The storage device 400 may also be independently connected to the network 100 by a link 140, which may also be either wired, wireless or optical, for example. The storage device 400 may be Read-Only Memory (ROM), erasable ROM, disk, flash, etc. Although shown separately, the storage device 400 and the performance reproduction device 300 may be incorporated within the same physical unit, i.e., as part of the performance reproduction device 300. For example, the storage device 400 may be located within the enhanced radio or television set. If the storage device 400 is provided separately, the performance reproduction device 300 may directly retrieve information from the storage device 400. For example, the performance reproduction device 300 may access the storage device 400 located at a local server of the network 100 that is directly accessible via local connections. In this way, local network resources more dedicated to a smaller number of end-users are leveraged to conserve network resources that may be utilized by a larger number of end-users.

The performance recording device 800 may be coupled to the network 100 via a link 150, which may also be either wired, wireless or optical, for example. The performance recording device 800 may be, for example, a VCR, audio recording device, or the like of an end-user. The performance recording device 800 has access to the storage device 400 and the performance reproduction device 300 via links 802 and 804, respectively, which may also be either wired, wireless or optical, for example. The performance reproduction device 300 may also have direct access to the storage device 400 via a link 310, which may also be either wired, wireless or optical, for example.

Although the performance reproduction device 300, the storage device 400 and the performance recording device 800 are shown as physically separate units, it should be appreciated that two or more of the performance reproduction device 300, the storage device 400 and the performance recording device 800 may be incorporated within a single unit. For example, the storage device 400 may be located within the performance reproduction device 300 or the performance recording device 800, and/or the performance reproduction device 300 and the performance recording device 800 may be incorporated within a single unit.

It should also be appreciated that if the performance reproduction device 300, the storage device 400 and the performance recording device 800 share one of the network connection links 140, 150 and 160, the other ones of the links 140, 150 and 160 may be unnecessary.

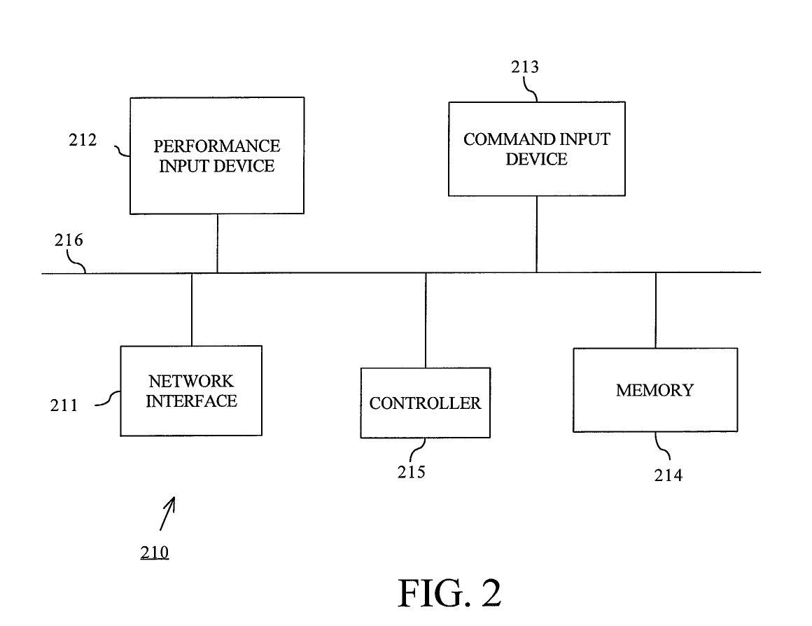

The performance transmitters 210, 220 and 230 may be conventional performance transmitters, such as conventional television or radio broadcasting stations or the like, or may be enhanced performances transmitters. FIG. 2 shows an exemplary block diagram of an enhanced performance transmitter 210 of FIG. 1. The enhanced performance transmitter 210 may include a network interface 211, a performance input device 212, a mixing command input device 213, a memory 214, and a controller 215, all of which are interconnected by a signal bus 216.

The performance input device 212 receives performance information, such as real-time voice input from a radio announcer or a television news anchor, or receives pre-recorded information such as advertisements or the like. The real-time performance information may be transmitted directly to the network 100 via the network interface 211 or stored in the memory 214 and transmitted at a later time.

The command input device 213 may include one or more input devices (not shown), such as a keyboard, mouse, or one or more manual switches, that enable an operator to input one or more commands. The one or more commands may be transmitted to the network 100 via the network interface 211 or saved in the memory 214 for later transmission as controlled by the controller 215. When received, the commands activate reproduction of performance information for a pseudo-live performance, as described in more detail below.

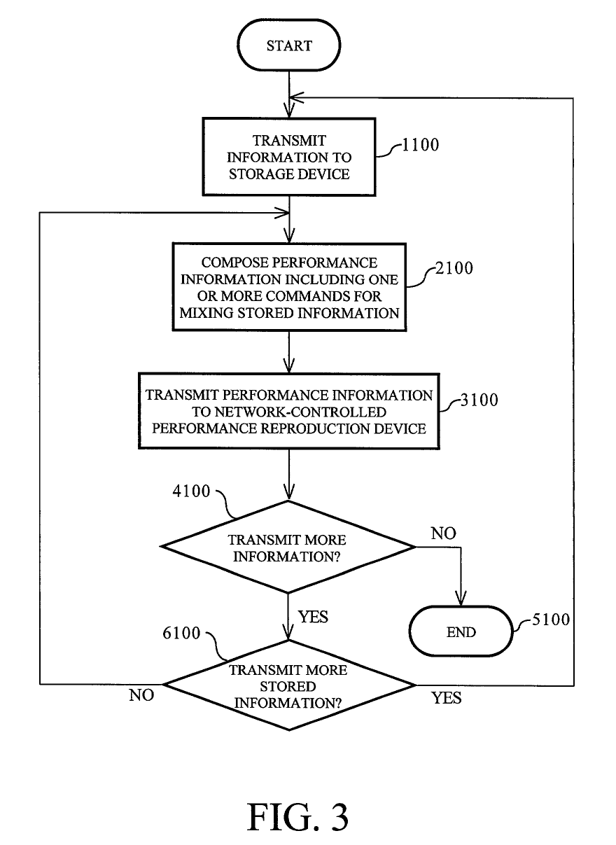

FIG. 3 is a flowchart of an exemplary process for transmitting a performance. In step 1100, the process transmits information such as songs, etc. to be stored in the storage device 400 via the network interface 211, for example. It should be appreciated that step 1100 may not be necessary because information may have been pre-stored in the storage device 400. The process then goes to step 2100. In step 2100, the process composes performance information including one or more commands for reproducing a performance based on the stored information. The one or more commands may include performance-oriented commands, housekeeping commands, programming commands, or the like, described in more detail below, and/or may include commands for accessing other commands already stored in the performance reproduction device 300, as also described in more detail below. The composed performance information may also include real-time performance information and/or stored performance information. The process then goes to step 3100.

In step 3100, the process transmits the performance information to a network-controlled performance reproduction device 300 and goes to step 4100. In step 4100, the process determines whether any more information is to be transmitted. If no more information is to be transmitted, the process goes to step 5100 and ends. If more information is to be transmitted, the process goes to step 6100 and determines whether the information to be transmitted is to be stored in the storage device 400. If the information to be transmitted is to be stored in the storage device, the process returns to step 1100. If the information to be transmitted is not to be stored in the storage device 400, i.e., if the information to be transmitted is one or more commands or the like that are to be used immediately or temporarily stored in a buffer separate from the storage device 400, the process returns to step 2100.

A transmitter may transmit data to the storage device 400 while the performance reproduction device is reproducing stored information from the storage device 400. A radio station could transmit one or more commands to activate reproduction of stored information by the enhanced radio, for example; and then while the enhanced radio is reproducing the stored information, such as a song, transmit additional information, such as the following morning's news, for example. Furthermore, since the transmitter is not constrained to transmit synchronously with generation of the performance, the transmitter may transmit at speeds faster or slower than the performance. Thus, “bursting” technology or the like, in which information is transmitted at very high speeds, may be utilized. Further, if it is cost-effective to transmit data at slower-than-performance speeds using less-costly transmitting technology and equipment at off-peak periods of the network, for example, the information may be transmitted at slower-than-performance speeds.

In order to prevent unauthorized access, it may be desirable for the information stored in the storage device 400, or a portion of the information, to be encrypted such that it can only be read with the aid of a key. The key may be transmitted along with or as part of commands transmitted over the network 100. Alternatively, the key may be sent to an end-user separately by e-mail, regular mail, or be included with the performance reproduction device 300 (i.e., installed with the hardware), for example. The keys may be sent upon receipt of monthly payments, for example, or special keys may be sent to the end-user as a promotional tool for new features already stored in the storage device 400.

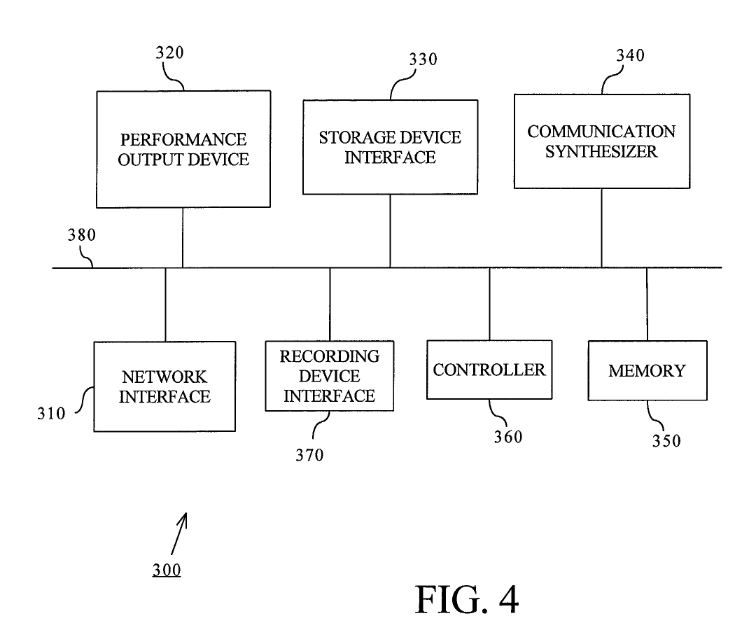

FIG. 4 is an exemplary block diagram of the performance reproduction device 300. The performance reproduction device 300 may include a network interface 310, a performance output device 320, a storage device interface 330, a communication synthesizer 340, a memory 350, a controller 360, and a recording device interface 370 all of which are interconnected by a signal bus 380. The performance reproduction device 300 receives performance information from the network 100 via the network interface 310. The network interface 310 may include wired, optical or wireless interfaces such as an antenna, satellite dish or the like.

The communication synthesizer 340 may perform audio or video synthesis. For example, if text data of a news broadcast or the like is received from the network 100, the communication synthesizer 340 may, using known or later-developed techniques, generate a spoken reproduction of the news broadcast based on the text data. As another example, when the performance reproduction device 300 is an enhanced television or the like, the communication synthesizer 340 may, using known or later-developed techniques, generate a video of a “virtual weatherman” giving a weather report based on text or other data received from the network 100. The communication synthesizer 340 may include an input device that allows an end-user to select synthesis options. For example, the end-user could select desired voice characteristics, a favorite newscaster, actor, or actress, or sign language or close-captioning options to be used in generating the pseudo-live performance. Language translation functions may also be provided in the communication synthesizer 340 so that, for example, an end-user may “tune in” to an English radio station, but hear the performance in Spanish.

The memory 350 may store data such as programs or control parameters and may also serve as a buffer for information received from the network 100. For example, the memory 350 may store information transferred from, or information to be transferred to, the storage device 400 or buffer information received from the network 100. In fact, the memory 350 may be a part of the storage device 400 or vice versa. The controller 360 controls where the information received from the network 100 is stored.

When the performance information is received from the network 100 via the network interface 310, the controller 360 may cause the performance information to be sent directly to the performance output device 320 or stored in the memory 350 for later output based on commands either received from the network 100 or generated by a program in the memory 350, for example. The program may function based on a profile that indicates end-user preferences. When a command is received from the network 100 via the network interface 310, the controller 360 may, based upon the command, retrieve information from the memory 350 or from the storage device 400 via the storage device interface 330 for output to the performance output device 320 for the pseudo-live performance.

The controller 360 may cause performance information received from the network 100 to be stored in the storage device 400 for subsequent reproduction. The controller 360 may even send performance information to the performance output device 320 and the storage device 400 at the same time. For example, when the performance information is a newly released song or movie, it may be output via a speaker or television monitor while being transmitted from a transmitting station, and simultaneously recorded in the storage device 400 for subsequent reproduction.

The recording device interface 370 interfaces with the performance recording device 800 for transmission of performance information between the performance recording device 800 and the performance reproduction device 300.

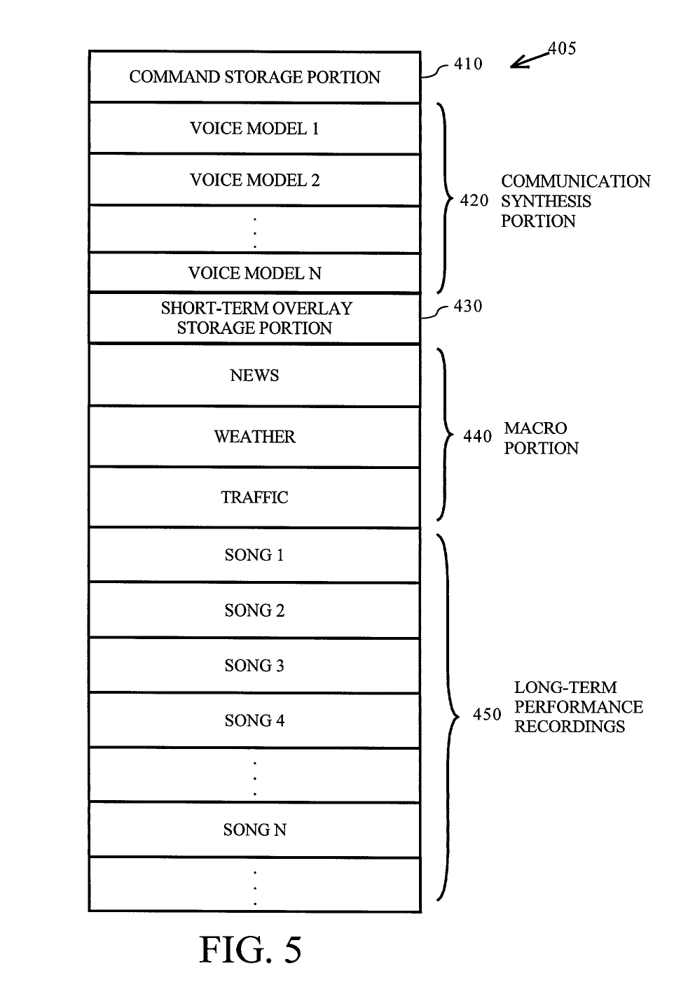

FIG. 5 shows an exemplary diagram of the storage device contents 405. The storage device contents 405 may include a command storage portion 410, a communication synthesis portion 420 including voice models and/or other communication synthesis data, a short-term overlay storage 430, a macro portion 440 including news, weather and traffic storage portions, for example, and long-term performance recordings 450 such as songs 1-N where N is a positive integer.

The command storage portion 410 may store individual commands and/or command sequences, such as are described in detail below. Furthermore, the command portion may contain pre-stored commands or command sequences, and/or commands or command sequences that have been transmitted over the network 100.

Commands may include performance commands, housekeeping commands, programming commands (i.e., software programs as compared to “radio” programs, for example) or the like. Performance commands may be, for example, commands for reproducing information from specified locations of the storage device 400. Examples of performance commands are given in the following Table 1.

TABLE 1

| | Command | | | | |
|---|---|---|---|---|---|
| 1 | Code | Time | Duration | Pointer | - - - |
| 2 | Play 1 | Immediate | 5 min. | attached | - - - |
| 3 | Play 2 | 12:00 p.m. | 2 min. | file id | - - - |
| 4 | Repeat daily | 12:02 p.m. | <5 min. | macro id | - - - |
| . | . | . | . | . | . |
| . | . | . | . | . | . |
| . | . | . | . | . | . |

Row 1 of Table 1 shows that a performance command may include a command code, time, duration, and pointer parameters, for example. Other parameters may also be included in a command as indicated by the dashes. Rows 2-4 show examples of possible commands. Row 2 shows a “Play 1” command code that instructs the performance reproduction device 300 to output performance information appended to the command beginning immediately and continuing for five minutes. The Play 1 command code may also include a pointer to a file in the storage device 400. For example, a special value of “FFFFₓ” may indicate “attached” and any other value may indicate a pointer in the storage device 400.

Row 3 shows a “Play 2” command code that instructs the performance reproduction device 300 to reproduce a stored information located at file id beginning at 12:00 p.m. and continuing for 2 minutes. Row 4 shows a “Repeat daily” command code that instructs the performance reproduction device 300 to generate a performance using a macro at macro id beginning at 12:00 p.m. and continuing for less than five minutes. A macro may be a predetermined sequence of commands or special set of program instructions to perform a sequence of functions. The “Repeat daily” command may, for example, execute a macro that reproduces a news broadcast using the above-described communication synthesizer 340.

In the above-described performance commands, the “duration” may correspond exactly to the duration of the information to be reproduced. Alternatively, the performance reproduction device 300 may, for example, insert predetermined filler material before and/or after the stored information, and/or increase or decrease the playback speed (e.g., by evenly distributing or removing short intervals of silence, or actually increasing or decreasing the time used for playback) in order to fill the instructed duration. For example, if the indicated “duration” is five minutes, but the stored information only requires four minutes and fifty-three seconds to reproduce, the performance reproduction device may insert a six-second message, such as “You are listening to station 98.7, WMZQ”, and a one-second interval of silence. Alternatively, rather than containing a “duration” designation, a command may contain instructions to begin a performance reproduction after a previous command has been executed, without reference to a particular time of day.

Housekeeping commands may include, for example, commands for manipulating or reorganizing information in the storage device 400. Some examples of housekeeping commands are given in the following Table 2.

TABLE 2

| | Command | | | Pointer or | |
|---|---|---|---|---|---|
| 1 | Code | Type | Size | Name | - - - |
| 2 | Load | movie | 33 Gigabytes | attached | - - - |
| 3 | Delete | traffic | 11 Megabytes | file id | - - - |
| 4 | Overlay | weather | 18 Megabytes | file id | - - - |
| 5 | Change | voice model | 18 Megabytes | file id | - - - |
| . | . | . | . | . | . |
| . | . | . | . | . | . |
| . | . | . | . | . | . |

Row 1 of Table 2 shows that a performance command may include a command code and type, size, and pointer or name parameters, for example. Additional or alternative parameters may also be included in a command. Rows 2-5 show examples of housekeeping commands. Row 2 shows a “Load” command that loads an attached (i.e., being transmitted via the network 100) 33 Gigabyte movie to a specified location of the storage device 400. Row 3 shows a “Delete” command that instructs that stored traffic information is to be deleted. Row 4 shows an “Overlay” command that instructs that stored weather information is to be replaced with new information. Row 5 shows a “Change” command that changes a voice model of a particular anchor person due to an actual change in the voice of the anchor person (e.g., if the anchor person caught a cold).

Programming commands (software programs) may include, for example, software instructions for controlling the performance reproduction device 300 to generate pseudo-live performance. For example, there may be programming commands such as “case statement”, “loop”, “if-then-else” and/or the like. Such well known commands may be used to create macros or complete program productions based on information received over the network 100 and/or information retrieved from the storage device 400.

The communication synthesis portion 420 of the storage device contents may contain voice models, image models and/or the like that the performance reproduction device 300 accesses to generate a synthesized performance based on text data or the like. For example, voice model 1 may be a generic male voice model, voice model 2 a generic female voice model, voice model 3 a voice model of a known radio or television personality, voice model 4 a voice model of an end-user's grandfather, and so forth.

The communication synthesis portion 420 may also contain information for reproducing habitual phrases, puns or the like of a particular radio or television personality or the like. For example, the communication synthesis portion 420 may contain a macro or recording to insert the phrase “Don't forget your umbrella today” during a synthesized weather forecast predicting rain. As another example, the communication synthesis portion 420 may contain a macro or recording to insert the phrase “Unbelievable!” after a 40-yard pass is caught or a kick-off is returned for a touchdown during a synthesized football game broadcast. It should be appreciated that such insertions may be implemented using pre-recorded voice segments of the desired phrases or words, they may also be implemented simply by using macros and voice model data.

One way of implementing such insertions into a synthesized performance would be use text or pattern recognition and macros. For example, the communication synthesizer 340 and/or or the controller 360 may contain a text recognition function that detects the word “rain” in proximity to a percentage greater than or equal to 50%, and a macro that outputs the “Don't forget your umbrella today” phrase when the word “rain” and the percentage greater than or equal to 50% are detected in proximity within the same text passage. During a football game, a pattern recognition function of the communication synthesizer 340 and/or or the controller 360 may detect that the football has crossed the goal line during a kickoff, and a macro may insert the “Unbelievable!” phrase.

The short-term overlay storage portion 430 may provide a storage location for temporary information, such as special announcements, advertisements, and/or the like, which will be subsequently replaced with fresh information. Information stored in the short-term overlay storage portion 430 may be in the form of text data that is used, in conjunction with information from the above-described communication synthesis portion 420, to generate synthesized performance.

The macro portion 440 may contain separate sections for news, weather and traffic, for example, and may be updated as appropriate through the network 100 via load commands. The news, weather and traffic sections may be used like the short-term overlay storage 430 described above, storing information that will subsequently be replaced, and may store information in the form of text data that will be used, in conjunction with information from the above-described communication synthesis portion 420, to generate synthesized performance. Furthermore, the news, weather and/or traffic sections may contain standard weather report recordings and/or text data segments, such as “Today will be partly cloudy,” “There is a 40% chance of rain,” “Today's high temperature will be in the 80's,” and so forth. In this case, rather than transmitting entire weather reports via the network 100, macro commands may be transmitted that activate reproduction of one or more appropriate standard recordings or text data segments that have been pre-stored in the macro portion 440. For example, a macro may be defined in which the three above-mentioned phrases are combined. When a command is received corresponding to this macro, the performance reproduction device outputs a synthesized or pre-recorded performance that says, “Today will be partly cloudy. There is a 40% chance of rain. Today's high temperature will be in the 80's.”

The long-term performance recordings portion 450 may include song storage sections Song 1-Song N (when the performance reproduction device 300 is an enhanced radio), movie storage sections (when the reproduction device is an enhanced television), and/or other types of performance recordings, for example. Each song storage section, movie storage section or the like may contain a pre-stored song or movie or the like, or may include empty sections, thus providing a space for a song or movie to be stored in the future. Parts of the long-term performance recordings portion 450 may be read only, while other parts may be overwritten by other information.

Each item of information in the long-term performance recordings portion 450, such as each song or movie, may be tagged with as much additional information as desired. For example, country music songs may be tagged with a “country” tag, songs about girls named “Charlene” may be appropriately tagged, and/or tags may be provided that cause the name of the song, the recording artist, and/or the like to appear on a display while the song is being reproduced. These tags may, for example, be accessed by the above-described commands. For example, a command may instruct that songs having a “Garth Brooks” tag be played in succession.

It should be appreciated that there may be various other portions included in the storage device 400, such as an advertisement portion, a commercial portion and/or the like. It should also be appreciated that the storage device may contain fewer storage portions than are shown in FIG. 5. For example, the storage device may contain only the long-term performance recordings portion 450.

The commands described above may be transmitted and/or stored as part of larger command sequences. This allows an extended period of pseudo-live performance generation to be programmed in advance. Exemplary command sequences are described below.

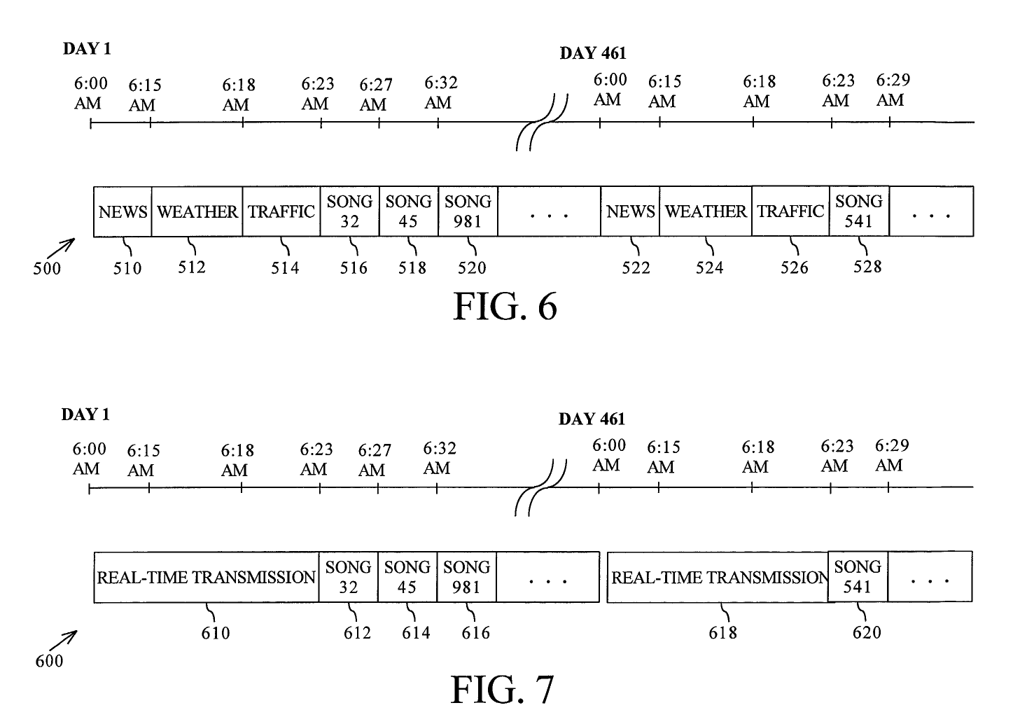

FIG. 6 is a diagram of one exemplary command sequence 500. The command sequence 500 includes “news” commands 510 and 522, “weather” commands 512 and 524, “traffic” commands 514 and 526, and “song” commands 516, 518, 520 and 528. In this example, at 6:00 AM on Day 1 of programming, the “news” command 510 causes news information to be reproduced from the “news” storage portion of the macro portion 440 (FIG. 5) of the storage device 400. Next, at 6:15 AM, the “weather” command 512 causes weather information to be reproduced from the “weather” storage portion of the macro portion 440 of the storage device 400. At 6:18 AM, the “traffic” command 514 causes traffic information to be reproduced from the “traffic” storage portion of the macro portion 440 of the storage device 400. Then “song” commands 516, 518 and 520 cause song 32, song 45 and song 981 to be reproduced from the long-term performance recordings portion 450 of the storage device 400 at 6:23 AM, 6:27 AM and 6:32 AM, respectively.

The command sequence 500 may be as long as desired, and may include commands for reproducing information that has not yet been stored. For example, the command sequence 500 includes the “news” command 522 for reproducing news information from the storage device 400 on Day 461 of programming, but it is obvious that, at the time the command sequence 500 is sent, the news for Day 461 is not yet known. Therefore, the “news” storage portion of the macro portion 440 of the storage device 400 will be updated with fresh news information for Day 461 at some time prior to 6:00 AM on Day 461, for example, and then this updated information will be reproduced at 6:00 AM on Day 461 based on the previously transmitted command sequence.

Furthermore, the command sequence 500 itself may be updated or interrupted. For example, according to the command sequence 500, song 541 is scheduled to be reproduced at 6:23 AM on Day 461. However, if it is desired to transmit an urgent and/or unexpected public announcement at 6:20 AM, for example, the public announcement may be transmitted and stored in the storage device 400 and a new command corresponding to the public announcement may be transmitted to replace the “song” command 528. Then, at 6:23 AM, rather than reproducing song 541, as previously scheduled, the performance reproduction device 300 will reproduce the public announcement. Alternatively, at 6:20 AM, the public announcement may, as a real-time transmission, interrupt the traffic information that is currently being reproduced based on the “traffic” command 526.

FIG. 7 is a diagram of another exemplary command sequence 600. The command sequence 600 is similar to the command sequence 500, except that the “news”, “weather” and “traffic” commands are replaced with “real-time transmission” blocks 610 and 618. In this case, rather than pre-storing news, weather and traffic information in the storage device 400, the news, weather and traffic information, and/or any other desired information, is transmitted in real-time to the performance reproduction device 300 during the indicated time blocks.

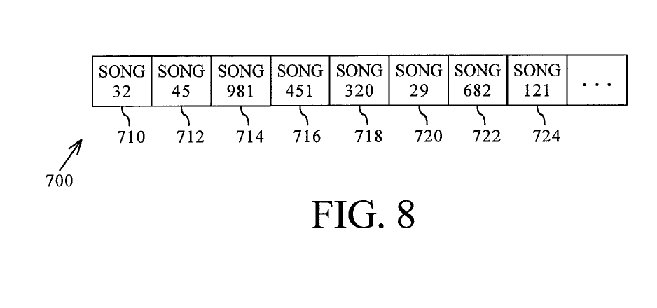

FIG. 8 is a diagram of yet another exemplary command sequence 700. The command sequence 700 is not necessarily time dependent. The command sequence 700 includes “song” commands 710, 712, 714, 716, 720, 722, 724, . . . , which cause songs to be reproduced from the storage device in the order of song 32, song 45, song 981, song 451, song 320, song 29, song 682, song 121, . . . . The order of the songs may be generated randomly, may be determined by a software program (programming commands), or may be selected as desired by one or more persons involved with transmitting or pre-storing the command sequence 700. Furthermore, the command sequence 700 may contain one or more commands corresponding to songs that have not yet been stored in the storage device.

Using the command sequence 700, the performance reproduction device 300 reproduces songs in the instructed order until a signal is received from the network 100. The performance reproduction device 300 treats this receipt of a signal as a command to reproduce performance information received from the network 100. The performance reproduction device 300 then inserts performance information received from the network 100 into the mix of information being reproduced.

In FIGS. 6-8, individual commands are part of larger command sequences. However, it should be appreciated that commands may be transmitted and/or stored individually, if desired or appropriate.

Program sequences may be generated by the reproduction device 300 by using programming commands such as loops, branches, if-then-else statements, and/or case statements as is well known to those skilled in software programming art. Special commands may handle real-time performances or account for unexpected circumstances such as storage failure, etc.

When it is desired to transmit information to the performance reproduction device 300, the performance transmitter 200 may, by keeping track of the time, know when a break, such as a break between songs, will occur and transmit a signal at this break. Alternatively, the performance transmitter 200 may transmit the signal at an arbitrary time, and the performance reproduction device 300 may receive the signal, temporarily store information transmitted from the performance transmitter via the network 100, and reproduce the transmitted information at the next available, or otherwise designated, break. Obviously, if a transmission from the performance transmitter 200 is urgent (e.g., national emergency), information such as a song, for example, that is currently being reproduced by the performance reproduction device 300 may be interrupted.

After the command sequence 700 has been thus interrupted and information received through the network 100 has been reproduced, the performance reproduction device 700 may continue reproducing songs according to the command sequence 700. Alternatively, a new command sequence may be followed.

Several examples of specific operations performed using the above-described network 100, performance transmitter 200, performance reproduction device 300 and storage device 400 are described below. In a first example, the performance transmitter 200 is a radio station, the performance reproduction device 300 is an enhanced radio, and the storage device 400 has been pre-loaded with a library of songs. A radio announcer speaks into a microphone, which is included in the performance input device 220 of FIG. 2, and says, for example, “Here are the three most-requested songs of this week.” The announcer then pushes one or more buttons, for example, on the command input device 230, and a command signal sequence including a Play 1 command appending the announcer's real-time performance is generated and transmitted to the network 100.

The announcer's voice information announcing “Here are the three most-requested songs of this week” is output through the performance output device 320, corresponding in this case to a radio speaker, based on the Play 1 command. The remaining command signal sequence is executed by retrieving the three songs from the storage device 400 and outputting them to the radio speaker in the order indicated by the command signal sequence.

The radio station may transmit addition program information any time before the reproduction of the songs is completed. For example, the radio announcer may announce, “We will be back with more music after these messages from our sponsors” and then issue commands for reproduction of pre-recorded commercials or the like. The corresponding commands are transmitted to the performance reproduction device 300 prior to the actual performance output time. Thus, the radio station is provided great flexibility in performance production because the time of performance production is not tightly coupled to the time of performance output.

In a second example, the performance transmitter 200 may be a television station, and the performance reproduction device 300 may be an enhanced television set. The end-user watches a new episode of a weekly program. While the end-user is watching the new episode, the new episode is simultaneously recorded to the storage device 400. Months later, it is decided to re-run the episode. However, rather than re-transmitting the entire episode, the television station transmits one or more command signals to the enhanced television set, instructing the enhanced television set to retrieve and output the episode from the storage device 400.

In a third example, the performance transmitter 200 is a radio station and the performance reproduction device 300 is an enhanced car radio. At 1:00 AM, the end-user is asleep at home in Washington, D.C., and is not listening to the car radio. However, the radio station receives world news information from the British Broadcasting Company in Great Britain, and automatically stores this information to the storage device 400, along with one or more commands. Later, at 7:30 AM, while driving to work, the end-user listens to the car radio. Based on the previously transmitted one or more commands, the car radio retrieves and reproduces the information that was stored earlier that morning beginning at 1:00 AM. In this manner, information may be transferred to the car radio at low network usage times and any time prior to the generation of a performance. Furthermore, from this example it is seen that a real-time radio announcer is not required.

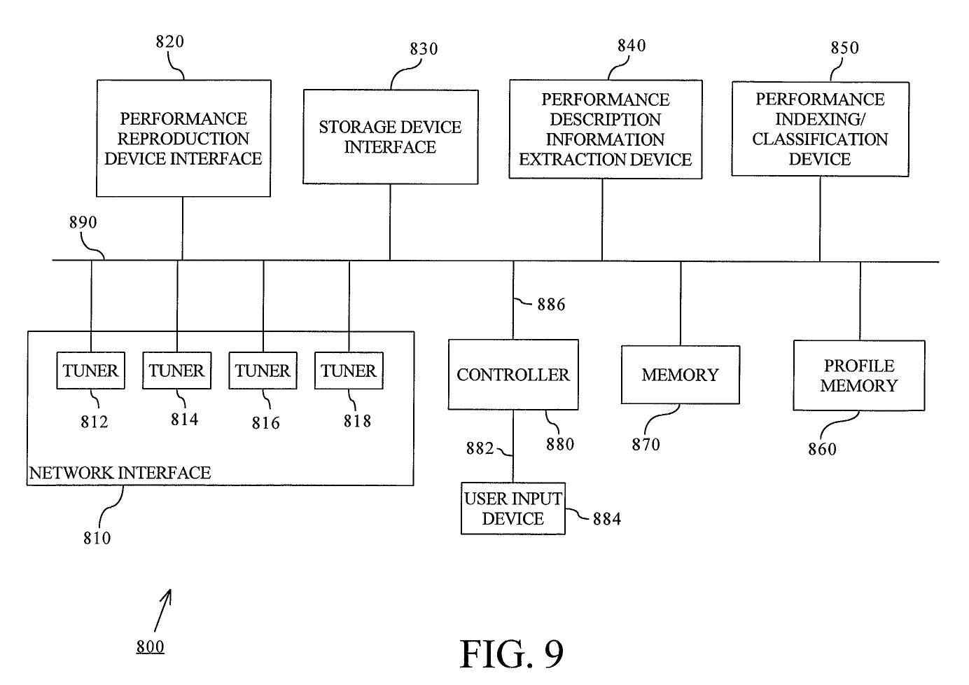

FIG. 9 is a diagram of a performance recording device 800 of FIG. 1. The performance recording device 800 may include a network interface 810, a performance reproduction device interface 820, a storage device interface 830, a performance description information extraction device 840, a performance indexing/classification device 850, a profile memory 860, a memory 870, and a controller 880, all of which are interconnected by a signal bus 890. A user input device 884 may be connected to the controller 880 via a suitable link 882, which may be wired, wireless or optical, and it should be appreciated that the user input device 884 may alternatively be connected to the controller 880 indirectly, such as by being connected via the network 100. Furthermore, a link 886 connecting the controller 880 to the signal bus 890 may be wired, wireless or optical. For example, the controller 880 and the user input device 884 could be incorporated in a hand-held remote control unit or the like.

The performance recording device 800 receives performance information from the network 100 via the network interface 810. The network interface 810 may include wired, optical or wireless interfaces such as an antenna, satellite dish or the like. The network interface 810 includes a plurality of tuners represented by tuners 812, 814, 816 and 818, each of which tunes to a different information stream. For example, when the performance recording device 800 is a VCR or the like, the tuner 812 may tune to television channel 2, the tuner 812 may tune to television channel 3, the tuner 816 may tune to television channel 4, the tuner 818 may tune to television channel 5, and so forth. One tuner may be provided for each possible information stream, or a limited number of tuners, such as four, for example, may be provided and an end-user may designate, through the user input device 884, up to four channels he or she wishes to simultaneously record.

The recording of information from the performance recording device 800 to the storage device 400 may be performed using any known or later-developed method. The link 802 (FIG. 1) between the performance recording device 800 and the storage device 400 may include multiple data paths or high bandwidth technology such as Dense Wavelength Division Multiplexing for optical links for simultaneous transmission of data to different areas of the storage device 400.

The performance description information extraction device 840 may extract performance description information from incoming performance information. For example, the performance description information extraction device 840 may extract movie titles, descriptions, ratings (such as G, PG, PG-13, R or the like) or the like if such information is provided as part of the header information, or in the form of tags or the like. The performance description information extraction device 840 may also, using pattern or voice recognition functions or the like, detect certain actors or actresses appearing in a performance.

The tag information, header information or the like may be included in incoming performance information, or may be received on a sideband or the like associated with the channel on which the incoming performance information is being received. Alternatively, the tag information, header information or the like may be received over a different channel. For example, the tuner 812 may be tuned to a dedicated “index channel”, on which tag information, header information or the like for one or more channels is received, and the tag information, header information or the like for programming received via the tuner 814, 816 or 818 could be received via the tuner 812. The receipt of the tag information, header information or the like via the tuner 812 may be concurrent with the receipt of performance information via the tuner 814, 816 or 818, or may be asynchronous with the receipt of performance information via the tuner 814, 816 or 818. In the latter case, for example, tag information, header information or the like for one or more channels may be received via the tuner 812, and the controller 880 may determine, based on a profile, for example (described in more detail below), which channel(s) to tune in via the tuners 814, 816 and/or 818, and the appropriate time at which to tune in and record.

The performance indexing/classification device 850 may, using information extracted by the performance description information extraction device 840, create an index of recorded performances, or otherwise classify the recorded performances. For example, the recorded performances could be indexed time-sequentially or alphabetically. The performances may alternatively or additionally be classified according to other parameters, such as “PG-rated movies”, “movies starring Harrison Ford”, “World War II movies”, “news clips about the recent earthquake in Japan”, and so forth. The index or indices generated by the performance indexing/classification device 850 may be displayed to an end-user when the end-user turns on the television, and/or when the user inputs a request to see the most recent version of the index or indices, for example.

The profile memory 860 stores profile information of a particular end-user or end-users. For example, if an end-user's favorite actor is Harrison Ford, the end-user may input this information to be stored in the profile memory 860, and when a movie starring Harrison Ford is detected, the controller 880 may exert appropriate control to cause the performance recording device 800 to record the movie. As another example, if the end-user's profile indicates that the end-user is 65 years old or older, the controller 880 may exert appropriate control to cause the performance recording device 800 to record live coverage of congressional proceedings on issues important to seniors. The profile memory 860 may be part of the storage device 400, or may be separate as shown.

The memory 870 may store data such as programs or control parameters and may also serve as a buffer for information received from the network 100 and/or the storage device 400. For example, the memory 870 may store information transferred from, or information to be transferred to, the storage device 400 or buffer information received from the network 100. In fact, the memory 870 may be a part of the storage device 400 or vice versa. The controller 880 controls where information received from the network 100 is stored.

The controller 880 may cause performance information received from the network 100 to be stored in the storage device 400 for subsequent reproduction. The controller 880 may even send performance information to the performance output device 320 and the storage device 400 at the same time. For example, when the performance information is a song or movie, it may be output via a speaker or television monitor while being transmitted from a transmitting station, and simultaneously recorded in the storage device 400 for subsequent reproduction.

Since the performance recording device 800 records performance information from a plurality of information streams, the performance reproduction device 300 is not limited to generating a performance based only on performance information received from one information stream. The performance reproduction device 300 may mix performance content associated with different information streams. This mixing may be done either automatically, in accordance with profile information, for example, or in response to a request input by an end-user. For example, an end-user may be viewing the Super Bowl, which typically contains numerous beer commercials. The end-user, however, does not drink beer, and may wish to view different commercials or other information, such as news headlines or the like, during the specified commercial breaks. The end-user may, either by inputting an instruction to the performance reproduction device 300 and/or the performance recording device 800 or by pre-specifying in his or her profile the types of commercials he or she wants or does not want to view, cause commercials from one or more different information streams to be reproduced during the specified commercial breaks. In this regard, sponsors of various performances may make a large selection of commercials, thus permitting the performance recording device 800 to select desired commercial performances.

Additionally, the end-user may have the option of simultaneously viewing and/or hearing performances based on performance information received from two or more different information streams. For example, news text information may be overlaid onto a movie the end-user is watching, such that the news text scrolls across the bottom of the television screen. As another example, the television screen may display two or more windows, with a movie from one channel being played in one window and a basketball game from another channel being played in another window. In the latter example, separate volume controls may be provided so that the user may independently control the volume of audio information associated with each channel. Thus, the user may view the movie with the volume turned up while viewing the basketball game with the volume off or turned down. If a congressional hearing is in progress, the user may desire the audio information to be converted into text, and the text scrolled on the bottom of the screen and/or stored in the storage device 400 for later perusal.

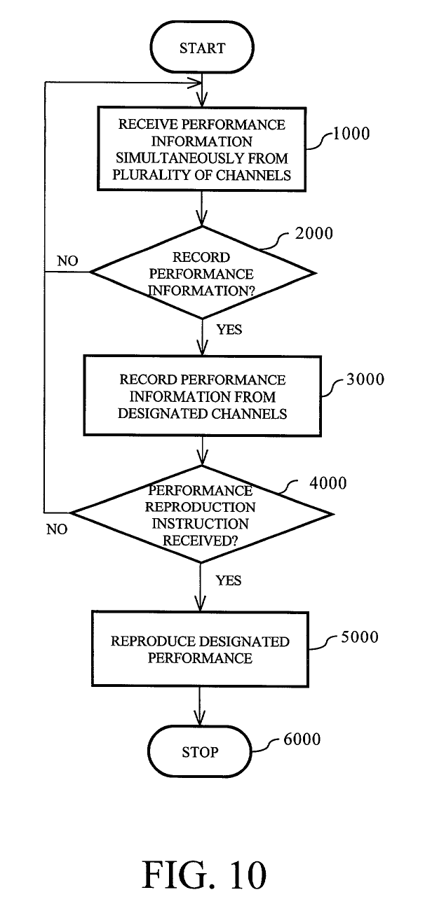

FIG. 10 is a flowchart of an exemplary method for recording a performance. In step 1000, the process receives performance information simultaneously from a plurality of information streams via the network 100 and goes to step 2000. The received performance information may be or include an entire movie, song or the like, or may be or include one or more commands for reproducing a movie, song or the like that is already stored in the storage device 400. In step 2000, the process determines whether to record any of the received performance information.

The determination of whether to record any of the received performance information may be based upon a direct user instruction, such as an instruction to “begin recording channels 9 and 12 at 7 pm”, and/or may be based on information contained in the profile memory 860. For example, if information contained in the profile memory 860 indicates that the end-user likes Harrison Ford movies, the determination of whether to record received performance information may be affirmative when a Harrison Ford movie is detected. As another example, when an end-user profile indicates that the end-user has an infant child, the determination of whether to record received performance information may be affirmative when a diapers commercial is detected or when a news story of new health concerns for infants is detected. As still another example, the end-user may be a do-it-yourself homeowner who is interested in laying a brick patio, and may have programmed the performance recording device 800 to detect and record do-it-yourself programs on laying brick patios.

As yet another option, if sufficient storage resources are available in the storage device 400, and if a separate tuner were provided for each possible information stream, the performance recording device could record and index all performances transmitted over the network 100. In this case, the determination to record performance information would always be “YES” by default.

If the determination to record performance information is negative, the program returns to step 1000. It should be appreciated that, if necessary, received information may be temporarily stored while the determination of whether to record the received information is being performed. For example, if pattern or voice recognition is to be performed on performance information in order to determine whether to record it, one or more portions of the performance information may need to be stored temporarily in a buffer or the like in order to perform the pattern or voice recognition.

When a determination is made to record performance information, the process proceeds to step 3000 and records the designated performance information from the appropriate information stream or streams. The process then advances to step 4000.

In step 4000, the process determines whether a performance reproduction instruction has been received. If a performance reproduction instruction has not been received, the process returns to step 1000. If a performance reproduction instruction has been received, the process proceeds to step 5000 and reproduces a designated performance based on the instruction, then goes to step 6000 and stops.

The performance reproduction instruction may be directly input by an end-user by, for example, the end-user viewing an index or menu of recorded performance information and selecting the performances he or she wishes to see and/or hear, or may be input automatically. As one example of automatic input, the performance reproduction instruction may be associated with the turning on of the performance reproduction device 300 and/or the performance recording device 800, such that turning on the performance reproduction device 300 and/or the performance recording device 800 automatically causes a performance to be output, such as a performance that the end-user instructed to be recorded in his or her absence. As another example of automatic input, the end-user may instruct the performance recording device 800 to detect certain performances, such as stock market reports, for example, and to automatically interrupt reproduction of any other performance when triggered by certain detected information. For example, if the end-user owns stock in McDonalds, the end-user may instruct the performance recording device 800 to monitor and/or record stock market reports and immediately, or at some specified time, reproduce stock market reports relating to McDonalds if the stock value exceeds or goes below a specified value.

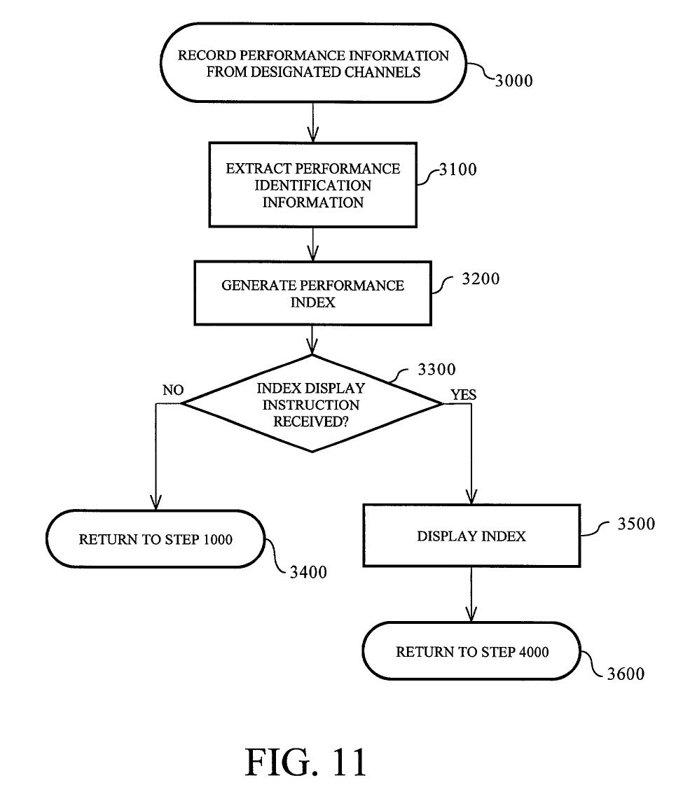

FIG. 11 is a flowchart of an exemplary method for generating and displaying a performance index. When performance information is recorded in step 3000, the process may proceed to step 3100 and extract performance identification information from the performance information, such as title, recording artist, starring actors and actresses, category, description, rating information, and/or the like. The process then proceeds to step 3200 and generates a performance index using the extracted identification information. The index may be arranged in any user-specified or default format, such as an alphabetical format, time-sequential format (i.e., what performances played at 6 pm, what performances played at 6:30 pm, etc.), or a categorical format (e.g., action movies, science fiction movies, and suspense/thriller movies may be listed under separate headings; movies may be listed by actor or actress; movies may be listed by rating (G, PG, and the like); etc.). The process then proceeds to step 3300.

In step 3300, the process determines whether an instruction to display the index has been received. If no instruction has been received, the process goes to step 3400 and returns to step 1000 of FIG. 10, although the process may alternatively return to step 3100, 3300, or any other appropriate point of the process of FIG. 10 or the process of FIG. 11. If an index display instruction has been received, the process goes to step 3500 and displays the index, such as by displaying the index on a television monitor or other display, outputting the index in audio form from a speaker of a radio, or the like. The process then continues to step 3600 and returns to step 4000 of FIG. 10.

It should be appreciated that many of the steps of the process of FIGS. 10 and 11 may be performed concurrently with other steps. Furthermore, it should be appreciated that some embodiments of the invention may not implement certain ones of the steps shown in FIGS. 10 and 11.

The performance transmitter 200, the performance reproduction device 300 and the performance recording device 800 can each be implemented on a general purpose or special purpose computer, a programmed microprocessor or microcontroller and peripheral integrated circuit elements, an application specific integrated circuit (ASIC) or other integrated or non-integrated circuit, a programmable logic device such as a PLD, PLA, FPGA or PAL, or the like, or any appropriate combination thereof. In general, any device capable of implementing at least some portions of the flowcharts shown in FIGS. 3, 10 and 11 can be used to implement the performance transmitter 200, the performance reproduction device 300 or the performance recording device 800.

Using the above-described embodiments, performance information may be recorded simultaneously from a plurality of information streams. The recorded performance information may be live transmission, and/or “pseudo-live” transmission may be performed in which, although the performance reproduced by a performance reproduction device has the appearance of a “fully live” transmission, part of the performance has actually been stored in or near the performance reproduction device in advance. The end-user may not even realize that this is the case.

The above-described invention is particularly well adapted for receiving digital performance information from a digital network, but may also be used to receive analog performance information.

While the invention has been described in conjunction with the specific embodiments described above, many equivalent alternatives, modifications and variations will become apparent to those skilled in the art once given this disclosure. For example, the performance transmitter 200, the performance reproduction device 300 and the performance recording device 800 are shown in FIGS. 2, 4 and 9 using bus architecture when any other architecture may be used as is well known in the art. Accordingly, the exemplary embodiments of the invention as set forth above are considered to be illustrative and not limiting. Various changes to the described embodiments may be made without departing from the spirit and scope of the invention.

What is claimed is:

1. A method for recording performance information, comprising:
receiving performance information from a plurality of performance information streams via separate tuners; and
storing the performance information received from at least two of the performance information streams in a single storage device.

2. The method according to claim 1, further comprising generating a performance based on the performance information stored from at least one of the performance information streams.

3. The method according to claim 2, wherein generating the performance is performed based on performance information stored from two of the performance information streams.

4. The method according to claim 3, wherein a portion of a performance based on performance information from one performance information stream is replaced with a portion of a performance based on performance information from another performance information stream.

5. The method according to claim 3, wherein a first performance based on performance information from a first performance information stream is generated simultaneously with generation of a second performance based on performance information from a second performance information stream.

6. The method according to claim 5, wherein generating a first performance based on performance information from a first performance information stream simultaneously with generation of a second performance based on performance information from a second performance information stream comprises one of (1) overlaying the first performance onto the second performance and (2) displaying the first and second performances in separate windows.

7. The method according to claim 1, further comprising:
extracting performance description information from received performance information, and
generating an index based on the performance description information.

8. The method according to claim 7, further comprising:
obtaining profile information, and
organizing the index based on profile information.

9. A performance information recording apparatus, comprising:
a performance information reception device that receives performance information from a plurality of performance information streams via separate tuners; and
a recording device that stores the performance information received from at least two of the performance information streams in a single storage device.

10. The performance information recording apparatus according to claim 9, further comprising a performance generator that generates a performance based on the performance information stored from at least one of the performance information streams

11. The performance information recording apparatus according to claim 10, wherein the performance generator generates the performance based on performance information stored from two of the performance information streams

12. The performance information recording apparatus according to claim 11, wherein a portion of a performance based on performance information from one performance information stream is replaced with a portion of a performance based on performance information from another performance information stream

13. The performance information recording apparatus according to claim 11, wherein a first performance based on performance information from a first performance information stream is generated simultaneously with generation of a second performance based on performance information from a second performance information stream

14. The performance information recording apparatus according to claim 13, wherein generating a first performance based on performance information from a first performance information stream simultaneously with generation of a second performance based on performance information from a second performance information stream comprises one of (1) overlaying the first performance onto the second performance and (2) displaying the first and second performances in separate windows

15. The performance information recording apparatus according to claim 9, further comprising:
a performance description information extraction device that extracts performance description information from received performance information, and
a performance indexing/classification device that generates an index based on the performance identification information

16. The performance information recording apparatus according to claim 15, further comprising:
a profile memory storing one or more profiles, wherein the performance indexing/classification device obtains profile information from the profile memory and organizes the index based on the profile information.
